(19) United States
(12) Patent Application Publication
(10) Pub. No.: US 2026/0081299 A1
(43) Pub. Date: Mar. 19, 2026

(54) MULTI-TIER BATTERY PACK HAVING AN INVERTED TIER OF CYLINDRICAL CELLS

(71) Applicant: Ford Global Technologies, LLC, Dearborn, MI (US)

(72) Inventor: Erik Billimoria, Canton, MI (US)

(21) Appl. No.: 18/886,032

(22) Filed: Sep. 16, 2024

(51) Int. Cl. H01M 50/358; B60L 50/64; H01M 50/213; H01M 50/289; H01M 50/505

(52) U.S. Cl. CPC H01M 50/358; B60L 50/64; H01M 50/213; H01M 50/289; H01M 50/505; H01M 2220/20

(57) ABSTRACT

A traction battery pack assembly includes a first tier of cylindrical battery cells; and a second tier of cylindrical battery cells. The second tier is inverted relative to the first tier. Another traction battery pack assembly includes an enclosure assembly providing an interior area; a first plurality of cylindrical battery cells disposed on a first tier within the interior area; a second plurality of cylindrical battery cells disposed on a second tier within the interior area; and a busbar assembly sandwiched between the first tier and the second tier. The busbar assembly has a first side contacting first terminals of the first plurality of cylindrical battery cells. The busbar assembly has an opposite, second side contacting second terminals of the second plurality of cylindrical battery cells. A polarity of the first terminals is the same as a polarity of the second terminals.

### TECHNICAL FIELD

This disclosure relates generally to a battery pack having multiple tiers of cylindrical cells and, more particularly, to such a battery pack where at least one of the tiers of cylindrical cells is inverted.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack assembly, including: a first tier of cylindrical battery cells; and a second tier of cylindrical battery cells, the second tier of cylindrical battery cells inverted relative to the first tier of cylindrical battery cells.

In some aspects, the techniques described herein relate to a traction battery pack assembly, wherein the second tier of cylindrical battery cells is a vertically above the first tier of cylindrical battery cells.

In some aspects, the techniques described herein relate to a traction battery pack assembly, further including a busbar assembly sandwiched between the first tier of cylindrical battery cells and the second tier of cylindrical battery cells.

In some aspects, the techniques described herein relate to a traction battery pack assembly, wherein each of the cylindrical battery cells in the first tier of cylindrical battery cells have a positive terminal that contacts the busbar assembly, wherein each of the cylindrical battery cells in the second tier of cylindrical battery cells have a positive terminal that contacts the busbar assembly.

In some aspects, the techniques described herein relate to a traction battery pack assembly, wherein each of the cylindrical battery cells in the first tier of cylindrical battery cells have a negative terminal that contacts the busbar assembly, wherein each of the cylindrical battery cells in the second tier of cylindrical battery cells have a negative terminal that contacts the busbar assembly.

In some aspects, the techniques described herein relate to a traction battery pack assembly, wherein the first tier and the second tier are disposed within an enclosure assembly.

In some aspects, the techniques described herein relate to a traction battery pack assembly, wherein the second tier of cylindrical battery cells is a vertically above the first tier of cylindrical battery cells, wherein the first tier is elevated a distance from a floor of the enclosure assembly to provide a vertically lower venting chamber.

In some aspects, the techniques described herein relate to a traction battery pack assembly, wherein the second tier is recessed a distance from a cover of the enclosure assembly to provide a vertically upper venting chamber.

In some aspects, the techniques described herein relate to a traction battery pack assembly, wherein the first tier of cylindrical battery cells and the second tier of cylindrical battery cells are supported by structural foam.

In some aspects, the techniques described herein relate to a traction battery pack assembly, further including a plurality of supports that support the first tier of cylindrical battery cells in a position where the first tier is elevated above the floor.

In some aspects, the techniques described herein relate to a traction battery pack assembly, wherein the first tier of cylindrical battery cells and the second tier of cylindrical battery cells are constituents of a traction battery pack of an electrified vehicle.

In some aspects, the techniques described herein relate to a traction battery pack assembly, including: an enclosure assembly providing an interior area; a first plurality of cylindrical battery cells disposed on a first tier within the interior area; a second plurality of cylindrical battery cells disposed on a second tier within the interior area; and a busbar assembly sandwiched between the first tier and the second tier, the busbar assembly having a first side contacting first terminals of the first plurality of cylindrical battery cells, the busbar assembly having an opposite, second side contacting second terminals of the second plurality of cylindrical battery cells, a polarity of the first terminals is the same as a polarity of the second terminals.

In some aspects, the techniques described herein relate to a traction battery pack assembly, wherein the first terminals are positive terminals, wherein the second terminals are positive terminals.

In some aspects, the techniques described herein relate to a traction battery pack assembly, wherein the first tier is a vertically lower tier and the second tier is a vertically upper tier.

In some aspects, the techniques described herein relate to a traction battery pack assembly, wherein the first tier is elevated a distance from a floor of the enclosure assembly to provide a vertically lower venting chamber, wherein the second tier is recessed a distance from a cover of the enclosure assembly to provide a vertically upper venting chamber.

In some aspects, the techniques described herein relate to a traction battery pack assembly, wherein the first plurality of battery cells and the second plurality of battery cells are at least partially supported by a structural foam.

In some aspects, the techniques described herein relate to a traction battery pack assembly, wherein the first plurality of cylindrical battery cells of the first tier and the second plurality of cylindrical battery cells of the second tier are disposed within the enclosure without vertically overlapping any portion of the first plurality of cylindrical battery cells with any portion of the second plurality of battery cells.

In some aspects, the techniques described herein relate to a traction battery pack assembly, wherein the cylindrical battery cells within the first plurality of battery cells and the cylindrical battery cells within the second plurality of battery cells are configured to vent in opposite directions.

In some aspects, the techniques described herein relate to a traction battery pack assembly, wherein the cylindrical battery cells within the first plurality of battery cells are configured to vent downward, and the cylindrical battery cells within the second plurality of battery cells are configured to vent upward.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a side view of a portion of the battery pack of FIG. 2.

FIG. 4 illustrates a perspective view of a battery cell from the battery pack of FIG. 2.

### DETAILED DESCRIPTION

This disclosure details exemplary traction battery pack assemblies having multiple tiers of cylindrical battery cells. The battery cells of one of the tiers are inverted relative to the battery cells of the other tier. A busbar assembly can be sandwiched between the tiers. Positive terminals of the cells in the first and second tiers can contact opposing sides of the busbar assembly. Alternatively, negative terminals of the first tier and the second tier can contact opposing sides of the busbar assembly.

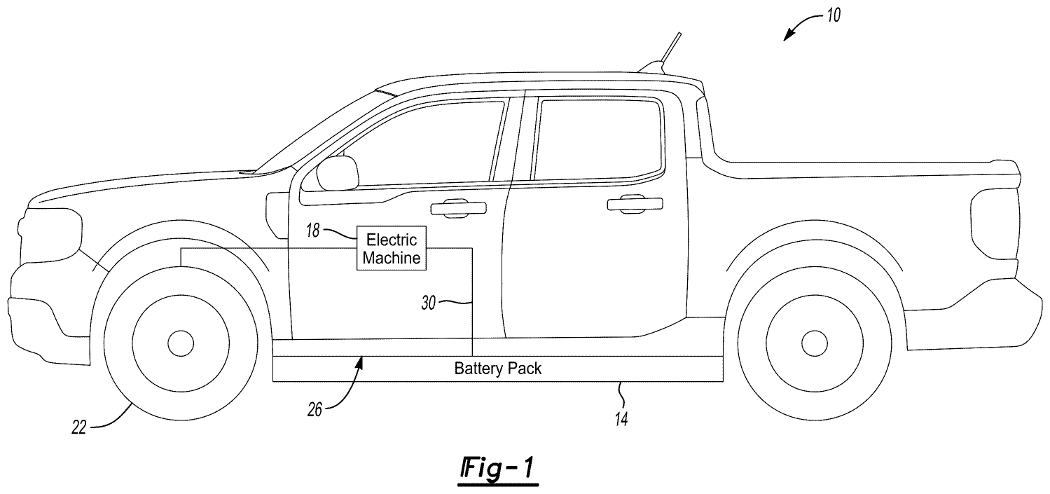

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

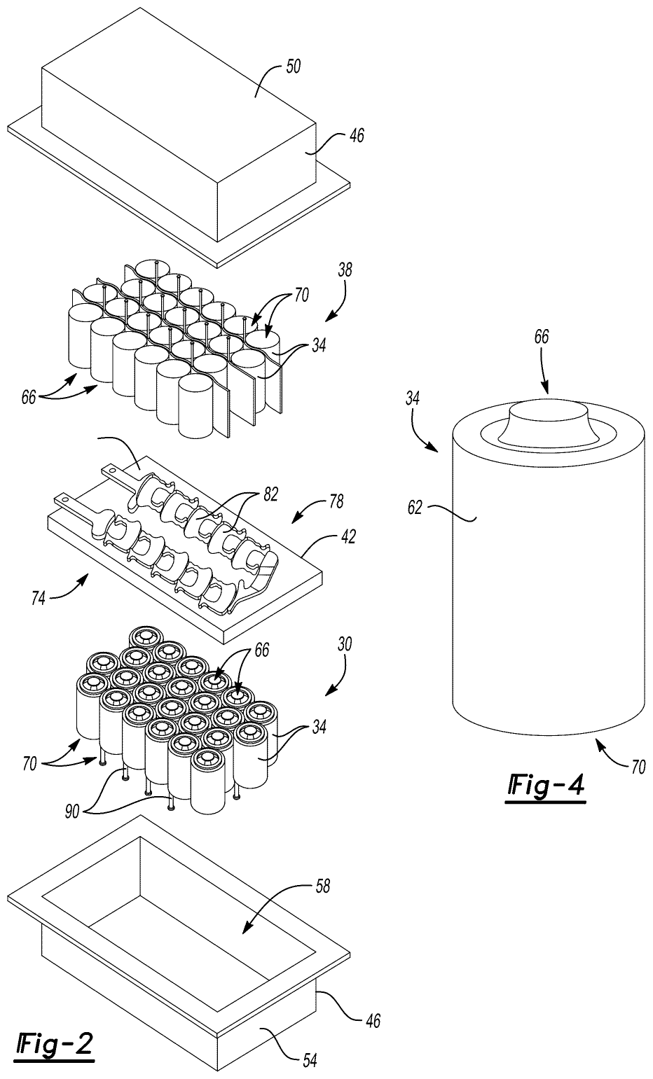

With reference now to FIGS. 2-4, the battery pack 14 includes a first tier 30 of cylindrical battery cells 34, a second tier 38 of cylindrical battery cells 34, and a busbar assembly 42. The first tier 30, the second tier 38, and the busbar assembly 42 are housed within an enclosure assembly 46. The enclosure assembly 46 includes an enclosure cover 50 that is secured to an enclosure tray 54 to provide an interior area 58 for housing the first tier 30, the second tier 38, and the busbar assembly 42.

The cells 34 are cylindrical battery cells having a jellyroll-style electrode structure housed within an outer casing assembly 62. A cap 66 of the outer casing assembly 62 provides a positive terminal at a first axial end of the cylindrical cell 34. A side 68 of the outer casing assembly 62 provides a negative terminal and is disposed at an opposite, second axial end of the cylindrical cell 34.

In this example, the first tier 30 of cylindrical battery cells 34 is a vertically lower tier, and the second tier 38 of cylindrical battery cells 34 is a vertically upper tier. No portion of the first tier 30 of cylindrical battery cells 34 vertically overlaps with any portion of the second tier 38 of cylindrical battery cells. Vertical, for purposes of this disclosure is with reference to ground and a general orientation of the traction battery pack 14 when installed within the vehicle 10.

The exemplary second tier 38 of cylindrical battery cells 34 is inverted relative to the first tier 30 of cylindrical battery cells 34. In particular, the first tier 30 of cylindrical battery cells 34 is arranged such that the caps 66 that provide the positive terminals of the cylindrical battery cells 34 within the first tier 30 face vertically upward and contact the busbar assembly 42, and the second tier 38 of cylindrical battery cells 34 is configured such that the caps 66 that provide the positive terminals of the cylindrical battery cells 34 of the second tier 38 face vertically downward and can contact the busbar assembly 42. A polarity of the terminals in the first tier 30 that contact the busbar assembly 42 is thus the same as a polarity of the terminals in the second tier 38 that contact the busbar assembly 42. The second tier 38 is considered inverted relative to the first tier 30 because the positive terminals the second tier 38 face downward and the positive terminals of the first tier 30 face upward.

In this example, the first tier 30 of cylindrical battery cells 34 contacts a first side 74 of the busbar assembly 42. The second tier 38 of cylindrical battery cells 34 contacts an opposite second side 78 of the busbar assembly 42.

In other examples, the first tier 30 and the second tier 38 could be inverted such that the sides 70 of the cylindrical battery cells 34 of the first tier 30 contact the first side 74 of the busbar assembly 42, and the sides 70 of the cylindrical battery cells 34 within the second tier 38 contact the second side 78 of the busbar assembly 42.

The busbar assembly 42 can include a plurality of individual busbars 82 held within a housing structure 86. At least some of the individual busbars 82 can face downwards to contact the first tier 30 of cylindrical battery cells 34. At least some of individual busbars 82 can face upwards to contact the second tier 38 of cylindrical battery cells 34. The cylindrical battery cells 34 within the first tier 30 and the second tier 38 can be electrically coupled to each other and to other components of the battery pack 14 and the vehicle 10 through the busbar assembly 42.

The example traction battery pack 14 includes a plurality of supports 90 that support the first tier 30 of cylindrical battery cells 34 in a position where the first tier 30 of cylindrical battery cells 34 is vertically elevated above a floor 88 of the enclosure tray 54. Supporting the first tier 30 of cylindrical battery cells 34 in a position spaced from the floor 88 provides a vertically lower venting chamber 94.

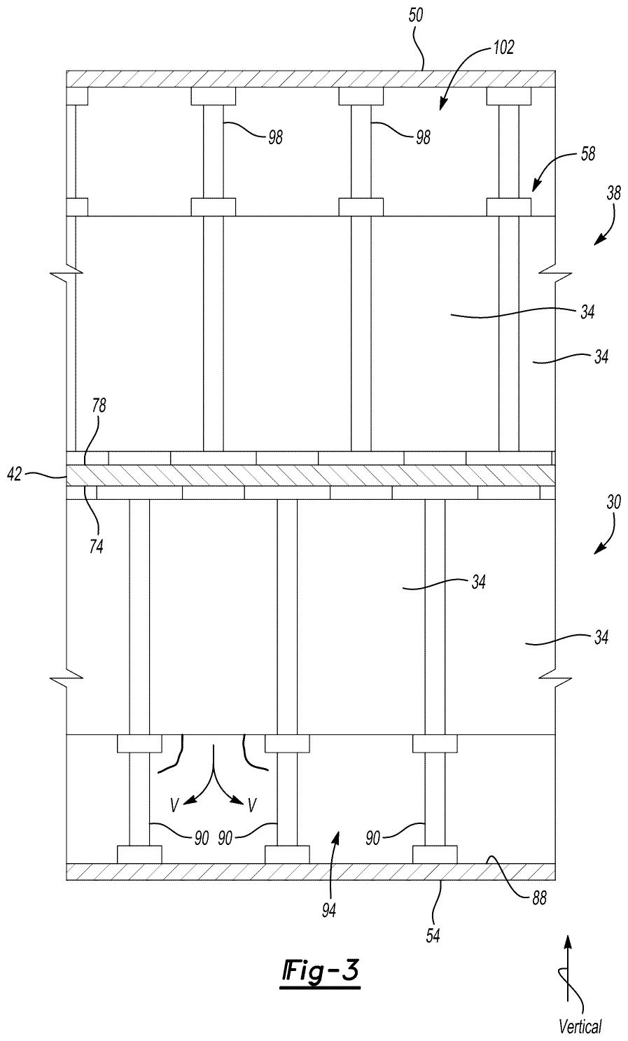

The example cylindrical battery cells 34 are configured to vent through the sides 70. Should one or more of the cylindrical battery cells 34 within the first tier 30 experience a thermal event leading to a discharge of vent byproducts V (FIG. 3) from within the outer casing assembly 62, the vent byproducts V can be accommodated within the vertically lower venting chamber 94 until discharged from the enclosure assembly 46. The plurality of supports 90 can be made of a dielectric material such as a polymer-based material.

Structural foam can be introduced into open areas or voids within the interior area 58 to support and hold the cylindrical battery cells 34 of the first tier 30. The structural foam can fill gaps between the cylindrical battery cells 34 of the first tier 30 and can be blocked from filling the lower venting chamber 94. The structural foam can at least partially support the cylindrical battery cells 34 of the first tier 30.

The battery pack 14 further includes a plurality of upper supports 98 that support the cylindrical battery cells 34 within the second tier 38 at a position where the second tier 38 is recessed a distance from the enclosure cover 50. This provides a vertically upper venting chamber 102 to accommodate vent byproducts discharged from the cylindrical battery cells 34 of the second tier 38.

Structural foam can be introduced into the interior area 58 of the battery pack 14 to support and hold the cylindrical battery cells 34 within the second tier 38 at a position where those cylindrical battery cells 34 are recessed a distance from the enclosure cover 50. The structural foam can fill gaps between the cylindrical battery cells 34 of the second tier 38 and can be blocked from filling the upper venting chamber 102. The structural foam can at least partially support the cylindrical battery cells 34 of the first tier 30.

As needed, the battery pack 14 could additionally incorporate thermal management devices, such as cooling plates, in positions between the cylindrical battery cells 34 of the first tier 30 or the second tier 38. The thermal exchange devices can be utilized to manage thermal energy levels within the cylindrical battery cells 34 and within other components of the traction battery pack 14. The thermal exchange devices could include fins that extend between the cylindrical battery cells 34.

While the example battery pack 14 includes cylindrical battery cells 34 offset vertically from each other within different tiers, other examples could include offsetting tiers of the cylindrical battery cells 34 horizontally. For example, the first tier 30, the second tier 38, and the busbar assembly 42 could be rotated together ninety degrees about a horizontally extending axis.

The example battery pack 14 includes two tiers of cylindrical battery cells 34. In other examples, the battery pack 14 could include more than two tiers of cylindrical battery cells 34.

The example battery pack 14 inverts all the cylindrical battery cells 34 within the second tier 38 relative to the first tier 30. In other examples, some of cylindrical battery cells 34 of the second tier 38 could be inverted while others are not. Similarly, some of the cylindrical battery cells 34 of the first tier 30 could be inverted relative to other cylindrical battery cells 34 of the first tier 30.

Features of the disclosed examples include inverting battery cells within a tier of a battery pack having multiple tier of the battery cells. The inverting can enable battery cells that are inverted to sandwich and electrically connect to a busbar assembly. Another tier of the battery cells can connect to another side of the busbar assembly. This arrangement can reduce a packaging height of the battery cells and an overall height of the battery pack when compared to other multitier battery pack designs.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a first tier of cylindrical battery cells; and
a second tier of cylindrical battery cells, the second tier of cylindrical battery cells inverted relative to the first tier of cylindrical battery cells.

2. The traction battery pack assembly of claim 1, wherein the second tier of cylindrical battery cells is a vertically above the first tier of cylindrical battery cells.

3. The traction battery pack assembly of claim 1, further comprising a busbar assembly sandwiched between the first tier of cylindrical battery cells and the second tier of cylindrical battery cells.

4. The traction battery pack assembly of claim 3, wherein each of the cylindrical battery cells in the first tier of cylindrical battery cells have a positive terminal that contacts the busbar assembly, wherein each of the cylindrical battery cells in the second tier of cylindrical battery cells have a positive terminal that contacts the busbar assembly.

5. The traction battery pack assembly of claim 3, wherein each of the cylindrical battery cells in the first tier of cylindrical battery cells have a negative terminal that contacts the busbar assembly, wherein each of the cylindrical battery cells in the second tier of cylindrical battery cells have a negative terminal that contacts the busbar assembly.

6. The traction battery pack assembly of claim 1, wherein the first tier and the second tier are disposed within an enclosure assembly.

7. The traction battery pack assembly of claim 6, wherein the second tier of cylindrical battery cells is a vertically above the first tier of cylindrical battery cells, wherein the first tier is elevated a distance from a floor of the enclosure assembly to provide a vertically lower venting chamber.

8. The traction battery pack assembly of claim 7, wherein the second tier is recessed a distance from a cover of the enclosure assembly to provide a vertically upper venting chamber.

9. The traction battery pack assembly of claim 7, wherein the first tier of cylindrical battery cells and the second tier of cylindrical battery cells are supported by structural foam.

10. The traction battery pack assembly of claim 7, further comprising a plurality of supports that support the first tier of cylindrical battery cells in a position where the first tier is elevated above the floor.

11. The traction battery pack assembly of claim 1, wherein the first tier of cylindrical battery cells and the second tier of cylindrical battery cells are constituents of a traction battery pack of an electrified vehicle.

12. A traction battery pack assembly, comprising:
an enclosure assembly providing an interior area;
a first plurality of cylindrical battery cells disposed on a first tier within the interior area;
a second plurality of cylindrical battery cells disposed on a second tier within the interior area; and
a busbar assembly sandwiched between the first tier and the second tier, the busbar assembly having a first side contacting first terminals of the first plurality of cylindrical battery cells, the busbar assembly having an opposite, second side contacting second terminals of the second plurality of cylindrical battery cells, a polarity of the first terminals is the same as a polarity of the second terminals.

13. The traction battery pack assembly of claim 12, wherein the first terminals are positive terminals, wherein the second terminals are positive terminals.

14. The traction battery pack assembly of claim 12, wherein the first tier is a vertically lower tier and the second tier is a vertically upper tier.

15. The traction battery pack assembly of claim 12, wherein the first tier is elevated a distance from a floor of the enclosure assembly to provide a vertically lower venting chamber, wherein the second tier is recessed a distance from a cover of the enclosure assembly to provide a vertically upper venting chamber.

16. The traction battery pack assembly of claim 12, wherein the first plurality of battery cells and the second plurality of battery cells are at least partially supported by a structural foam.

17. The traction battery pack assembly of claim 12, wherein the first plurality of cylindrical battery cells of the first tier and the second plurality of cylindrical battery cells of the second tier are disposed within the enclosure without vertically overlapping any portion of the first plurality of cylindrical battery cells with any portion of the second plurality of battery cells.

18. The traction battery pack assembly of claim 12, wherein the cylindrical battery cells within the first plurality of battery cells and the cylindrical battery cells within the second plurality of battery cells are configured to vent in opposite directions.

19. The traction battery pack assembly of claim 18, wherein the cylindrical battery cells within the first plurality of battery cells are configured to vent downward, and the cylindrical battery cells within the second plurality of battery cells are configured to vent upward.
